(19) United States
(12) Patent Application Publication
(10) Pub. No.: US 2026/0360142 A1
(43) Pub. Date: Nov. 12, 2026

(54) SPACE-SKY-GROUND-TUNNEL-HOLE INTEGRATED UNFAVORABLE GEOLOGY IDENTIFICATION METHOD AND SYSTEM

(71) Applicant: SHANDONG UNIVERSITY, Jinan, Shandong (CN)

(72) Inventors: Zhenhao XU, Jinan (CN); Shucai LI, Jinan (CN); Peng LIN, Jinan (CN); Hang XIANG, Jinan (CN); Fumin LIU, Jinan (CN); Ruiqi SHAO, Jinan (CN); Huihui XIE, Jinan (CN)

(73) Assignee: SHANDONG UNIVERSITY, Jinan, Shandong (CN)

(21) Appl. No.: 19/118,949

(22) PCT Filed: Oct. 31, 2023
(86) PCT No.: PCT/CN2023/128811

§ 371 Date: Apr. 7, 2025

(30) Foreign Application Priority Data
Oct. 19, 2022 (CN) 202211276244.3

(51) Int. Cl. G06V 20/13; G06T 17/05; G06V 20/17

(52) U.S. Cl. CPC G06V 20/13; G06T 17/05; G06V 20/17

(57) ABSTRACT

A space-sky-ground-tunnel-hole integrated unfavorable geology identification method includes: obtaining remote sensing image data and a digital elevation model along a tunnel site area, and determining a key investigation area; predicating a type of unfavorable geology that may be present in the area; obtaining mineral and lithologic information of the key investigation area where an unfavorable geological body may exist obtained by means of a spectral test, and determining the position, range and scale of distribution of the unfavorable geological body in combination with an earth surface geophysical exploration result; determining relative positions of the unfavorable geological body and the tunnel; and according to a tunnel site area three-dimensional (3D) geological model and relative positions of the unfavorable geological body and a tunnel working face, selecting a corresponding drilling position, and finally determining the type and properties of the unfavorable geological body.

The present invention claims priority to Chinese Patent Application No. 202211276244.3, filed with the China National Intellectual Property Administration (CNIPA) on Oct. 19, 2022 and entitled “Space-sky-ground-tunnel-hole Integrated Unfavorable Geology Identification Method and System”, which is incorporated herein by reference in its entirety.

### TECHNICAL FIELD

The present invention belongs to the technical field of tunnel investigation, and in particular, relates to a space-sky-ground-tunnel-hole integrated unfavorable geology identification method and system.

### BACKGROUND

The description in this section merely provides background art information related to the present invention and does not necessarily constitute the prior art.

Geological disasters such as water inrush and mud gushing, landslide and large deformation often occur during tunnel construction, which may cause heavy casualty, severe economic losses, and severe social impact. Unfavorable geology such as faults and karst is the biggest culprit and challenge for tunnel disaster occurrence. Advanced geological prediction is the most direct and effective measure for accurately exploring the unfavorable geology such as faults and karst, and has become a necessary link in tunnel investigation and construction.

During tunnel construction at present, the unfavorable geological body in front of a tunnel working face can be accurately identified and positioned by using a traditional advanced geological prediction method such as a drilling method and a geophysical exploration method. However, the prior art most focuses on the accurate identification on the property and position of the unfavorable geological body, and the geological structure of a tunnel site area is not first mastered in the macroscopic level. If the advanced geological prediction inside the tunnel is performed after the analysis on earth surface mineral and geological structure information of the tunnel site area from the macroscopic level, and the property and position information of the unfavorable geological body in front of the tunnel working face is identified and predicted from the tunnel and drilling scales, the unfavorable geological body can be more comprehensively identified, and at the same time, whether a geological disaster may occur or not after the tunnel is excavated and the severity of the geological disaster can be predicted clearly. Specifically, in an aspect of identification and prediction of the unfavorable geological body in the tunnel, by using an advanced horizontal drilling method, changes of rock mass quality and stratum information in front of the tunnel working face can be directly discovered through core taking or intuitively known through drilling parameters, and this method is one of the most direct and effective advanced geological prediction methods. However, it has a limitation of “a peephole view”, a geological body between holes cannot be identified, and failure in unfavorable geological body reporting and exploration may be easily caused. Through the geophysical exploration method, the position, shape and scale of the unfavorable geological body can be accurately explored, but there is a problem of multiplicity of solution of geophysical exploration inversion, and it is difficult to directly define the type and property of the unfavorable geological body. In traditional geological investigation, the mineral analysis has unique advantages in identifying the type and property of the unfavorable geology. If a mineral analysis result may be integrated with the drilling method and the geophysical exploration method, the advantages of the mineral analysis in the aspect of identifying the type and property of the unfavorable geological body may be realized, and the advantages of the drilling method and the geophysical exploration method in the aspect of identifying the position, shape and scale of the unfavorable geological body may also be realized.

Based on the above, the inventor discovers that for investigation of complex mountainous tunnels, through the tunnel site area geological investigation only relying on a single data source, the identification on the unfavorable geological body in the tunnel is not comprehensive enough. Different investigation methods have respective limitations. Whether a geological disaster may occur or not after the tunnel is excavated and the severity of the geological disaster cannot not be predicted clearly enough, and it is difficult to provide an effective reference for the advanced geological prediction of the tunnel.

### SUMMARY

To solve the technical problems in the background art, the present invention provides a space-sky-ground-tunnel-hole integrated unfavorable geology identification method and system, which innovatively integrates an image spectrum technology with traditional geological prediction methods such as a drilling method and a geophysical exploration method to provide a set of multi-source three-dimensional (3D) investigation methods from a macroscopic level to a microscopic level, realizes precise identification on forms (positions, shapes and scales) and nature (types and properties) of an unfavorable geological body in a tunnel, and provides a beneficial reference for advanced geological prediction of the tunnel.

Through the image spectrum technology, non-contact measurement of earth surface minerals in a tunnel site area and surface minerals of surrounding rocks in a tunnel may be realized, and through remote sensing image analysis, geological lithologic information of a large range of area may be identified, and an area fault fracture zone may be predicted. By using a push-broom type spectral imager, rock mineral composition and types in the tunnel may be divided. Therefore, if the image spectrum technology is introduced into the tunnel geological investigation, efficiency of the tunnel geological investigation may be greatly improved, and multi-scale identification and prediction on the unfavorable geological body may be realized.

To achieve the above objectives, the present invention adopts the following technical solution:

According to a first aspect, the present invention provides a space-sky-ground-tunnel-hole integrated unfavorable geology identification method, which includes:
obtaining satellite remote sensing image data and a digital elevation model along a tunnel site area, and determining a key investigation area through geological analysis;
extracting corresponding geological structure information and lithologic information based on an unmanned aerial vehicle (UAV) remote sensing spectral image of the key investigation area, and recognizing a type of unfavorable geology possibly presenting in the key investigation area;
obtaining corresponding mineral and lithologic information based on a spectral test on the key investigation area possibly having an unfavorable geological body, and determining the position, range and scale of distribution of the unfavorable geological body in combination with an earth surface geophysical exploration result;
obtaining image spectral information of a geological body around a tunnel working face inside the tunnel in a position of the tunnel working face, identifying mineral and lithologic information inside the tunnel, and then determining relative positions of the unfavorable geological body and the tunnel working face in combination with a geophysical exploration test inside the tunnel and a tunnel site area 3D geological model; and
determining a drilling position according to the tunnel site area 3D geological model and the relative positions of the unfavorable geological body and the tunnel working face, and finally confirming the type and properties of the unfavorable geological body based on an on-site drilling test result.

As an implementation, the 3D geological model of the tunnel site area is built according to preliminary investigation data of the tunnel.

As an implementation, radar data is obtained in the tunnel site area by using a synthetic aperture radar interferometric measurement method, and a high-resolution digital elevation model is generated by processing the radar data.

As an implementation, spectrum feature, texture feature and geometrical feature information is extracted according to the remote sensing image data of the tunnel site area, and stratum lithologic and mineral information of the tunnel site area is obtained through inversion according to a corresponding relationship of the spectrum feature, texture feature and geometrical feature information with the minerals and the lithology.

Topographic feature information of the tunnel site area is extracted by using the digital elevation model.

An area having a fragile geological environment and a stability not meeting set requirements in the tunnel site area is predicted through the stratum lithologic and mineral information and the topographic feature, and is marked as a potential geological disaster hidden danger area, i.e., the key investigation area.

As an implementation, an UAV mounted spectral camera is used for performing spectral imaging in the determined key investigation area.

As an implementation, the mineral and lithologic information inside the tunnel is identified at the tunnel working face by using a push-broom type spectral imager.

According to a second aspect, the present invention provides a space-sky-ground-tunnel-hole integrated unfavorable geology identification system, which includes:
a key investigation area determining module, configured to obtain satellite remote sensing image data and a digital elevation model along a tunnel site area, and determine a key investigation area through geological analysis;
an unfavorable geology type prediction module, configured to extract corresponding geological structure information and lithologic information based on a UAV remote sensing spectral image of the key investigation area, and recognize a type of unfavorable geology possibly presenting in the key investigation area;
an unfavorable geological body distribution determining module, configured to obtain corresponding mineral and lithologic information based on a spectral test on the key investigation area possibly having an unfavorable geological body, and determine the position, range and scale of distribution of the unfavorable geological body in combination with an earth surface geophysical exploration result;
a relative position determining module, configured to obtain image spectral information of a geological body around a tunnel working face inside the tunnel in a position of the tunnel working face, identify mineral and lithologic information inside the tunnel, and then determine relative positions of the unfavorable geological body and the tunnel working face in combination with a geophysical exploration test inside the tunnel and a tunnel site area 3D geological model; and
an abnormality verification module, configured to determine a drilling position according to the tunnel site area 3D geological model and the relative positions of the unfavorable geological body and the tunnel working face, and finally confirm the type and properties of the unfavorable geological body based on an on-site drilling test result.

As an implementation, in the relative position determining module, the 3D geological model of the tunnel site area is built according to preliminary investigation data of the tunnel.

As an implementation, in the key investigation area determining module, radar data is obtained in the tunnel site area by using a synthetic aperture radar interferometric measurement method, and a high-resolution digital elevation model is generated by processing the radar data.

As an implementation, spectrum feature, texture feature and geometrical feature information is extracted according to the remote sensing image data of the tunnel site area, and stratum lithologic and mineral information of the tunnel site area is obtained through inversion according to a corresponding relationship of the spectrum feature, texture feature and geometrical feature information with the minerals and the lithology.

As an implementation, the key investigation area determining module is further configured to:
extract topographic feature information of the tunnel site area by using the digital elevation model; and
predict an area having a fragile geological environment and a stability not meeting set requirements in the tunnel site area through the stratum lithologic and mineral information and the topographic feature, and mark the area as a potential geological disaster hidden danger area, i.e., the key investigation area.

According to a third aspect, the present invention provides a computer-readable storage medium storing a computer program. The program, when executed by a processor, implements steps in the space-sky-ground-tunnel-hole integrated unfavorable geology identification method described above.

According to a fourth aspect, the present invention provides a computer device, which includes a memory, a processor and a computer program stored on the memory and runnable on the processor. The processor, when executing the program, implements the steps in the space-sky-ground-tunnel-hole integrated unfavorable geology identification method described above.

Compared with the prior art, the present invention has the following beneficial effects:

(1) The present invention uses the satellite remote sensing technology to identify an area growth fault fracture zone, and has macroscopic characteristics. Compared with satellite remote sensing, the UAV remote sensing has the advantages of high resolution, high image data quality and acquisition convenience. The on-site precise spectral information may be directly obtained through a ground spectrum test, and the accuracy of the remote sensing image is verified. Firstly, the key investigation area is marked by using the satellite remote sensing technology. Then, refined investigation is performed by using the UAV remote sensing. Finally, verification is performed by using the ground spectrum test. The type of unfavorable geology possibly presenting in the key investigation area may be fast and precisely identified.

(2) In the present invention, the position, range and scale, i.e., “form” of the unfavorable geological body can be identified by using the advantages of remote prediction of a geophysical exploration technology. The type and proportion, i.e., “nature” of the unfavorable geological body can be identified through directly obtaining the lithologic and mineral information of the unfavorable geological section by using the drilling technology. Through the combination of the two measures, the comprehensive identification on the “form” and “nature” of the unfavorable geological body can be realized.

(3) According to the present invention, the space-sky-ground-tunnel-hole unfavorable geology multi-scale identification prediction is performed based on image spectrum analysis. Through satellite remote sensing and UAV remote sensing images, the exploration range of the unfavorable geological body is greatly reduced from the macroscopic level to the microscopic level. Then, the range and type of the unfavorable geological body are identified by using the geophysical exploration method and the drilling method to form a set of multi-source 3D investigation method from the macroscopic level to the microscopic level, and the precise identification on the “form” and “nature” of the unfavorable geological body in a tunnel is realized.

The advantages in additional aspects of the present invention will be set forth in part in the description below, parts of which will become apparent from the description below, or will be understood by the practice of the present invention.

### BRIEF DESCRIPTION OF THE DRAWINGS

The accompanying drawings constituting a part of the present invention are used for providing a further understanding of the present invention. The exemplary embodiments of the present invention and descriptions thereof are used for explaining the present invention, and do not constitute an improper limitation of the present invention.

FIG. 1 is a flowchart of a space-sky-ground-tunnel-hole integrated unfavorable geology identification method according to an embodiment of the invention.

### DETAILED DESCRIPTION

The present invention will be further illustrated hereafter in combination with accompanying drawings and embodiments.

It should be pointed out that the following detailed descriptions are all illustrative and are intended to provide further descriptions of the present invention. Unless otherwise specified, all technical and scientific terms used herein have the same meanings as those usually understood by a person of ordinary skill in the art to which the present invention belongs.

It should be noted that the terms used herein are merely used for describing specific implementations, and are not intended to limit exemplary implementations of the present invention. As used herein, the singular form is intended to include the plural form, unless the context clearly indicates otherwise. In addition, it should further be understood that terms “include” and/or “including” used in this specification indicate that there are features, steps, operations, devices, components, and/or combinations thereof.

### Example 1

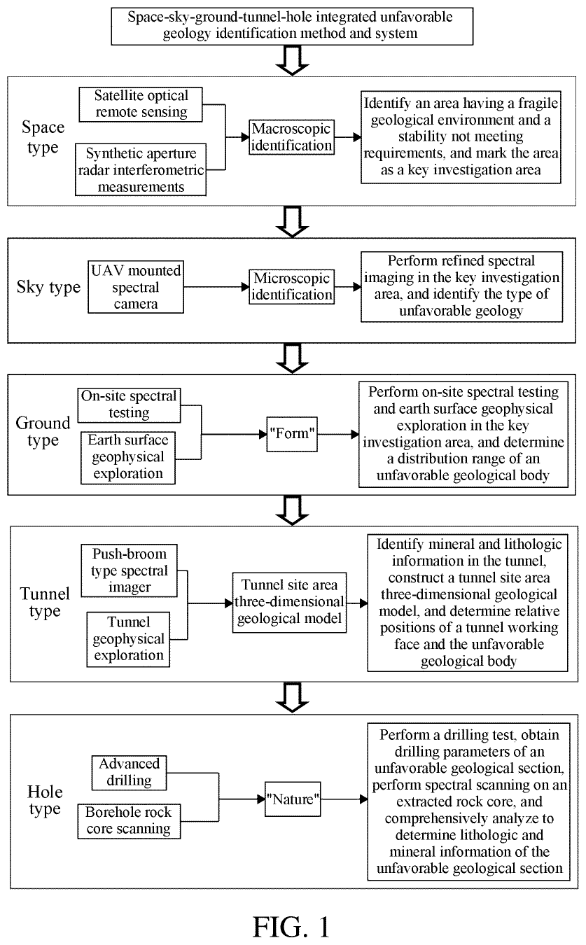

Referring to FIG. 1, the present example provides a space-sky-ground-tunnel-hole integrated unfavorable geology identification method, which specifically includes the following steps:

Step 1: obtaining satellite remote sensing image data and a digital elevation model along a tunnel site area, and determining a key investigation area through geological analysis.

In a specific implementation process of step 1, satellite optical remote sensing imaging is performed in the tunnel site area to obtain the remote sensing image data. Radar data is obtained in the tunnel site area by using a synthetic aperture radar interferometric measurement method, and a high-resolution digital elevation model is generated by processing the radar data. Through the obtained remote sensing image data, spectrum feature information of the tunnel site area is extracted, and stratum lithologic and mineral information of the tunnel site area is obtained through inversion according to a corresponding relationship of the spectrum feature with the minerals and the lithology. Topographic feature information of the tunnel site area is extracted by using the digital elevation model. Areas having a fragile geological environment and a stability not meeting set requirements in the tunnel site area are predicted through the stratum lithologic and mineral information and the topographic feature information, and the areas are marked as potential geological disaster hidden danger areas, i.e., the key investigation areas.

Specifically, a processing process of the radar data is as follows:
(1) registering repeated images covering the same area at different time periods
(2) generating an image interferogram through image filtering;
(3) based on a track parameter and position information of a center point of an imaging area, removing a flat phase, and obtaining topographic phase information in the image interferogram after image registering and flat phase removal processing;
(4) unwrapping processing is performed on the topographic phase information in the image interferogram to obtain a true value of the topographic phase; and
(5) the digital elevation model is obtained by using a phase-to-elevation conversion formula.

$$h = - \frac{λ}{4 π} \frac{L sin θ}{S cos ( θ - α )} φ .$$

In the formula, h is elevation information, φ is the true value of the topographic phase, L is a slant distance observed by a radar satellite to the ground in a captured primary image, θ is a radar-side view angle, α is a baseline inclination angle, and S is a space baseline.

An analysis process of the remote sensing image data is as follows:
(1) preprocessing the obtained satellite remote sensing image data, including radiation correction, atmospheric correction, and geometrical correction, so as to eliminate image background noises;
(2) extracting spectrum feature information of each point in the tunnel site area from the preprocessed satellite remote sensing image by using a spectrum angle matching method;
(3) performing a field on-site exploration, collecting typical rocks and minerals in the tunnel site area, and establishing a lithology spectrum library; and

(4) matching the lithologic and mineral information of the tunnel site area by using the spectrum feature information in combination with an existing spectrum database.

Step 2: extracting corresponding geological structure information and lithologic and mineral information based on a UAV remote sensing spectral image of the key investigation area, and recognizing the type of unfavorable geology possibly presenting in the key investigation area.

In a specific implementation process of step 2, a matched UAV model and a mounted spectral imager are selected and used according to satellite investigation data and the digital elevation model of the key investigation area, and a corresponding flight route is planned. A UAV flies in a designated route and obtains an aerial image of the key investigation area. The aerial image is processed to obtain a 3D geological model of the key investigation area. On-site investigation and sampling are performed on typical minerals to help verify the accuracy of the UAV aerial image. Geological interpretation work is performed for the 3D geological model, and the type of unfavorable geology possibly presenting in the area is predicated.

Selection requirements of the UAV are as follows:
(1) if the tunnel site area has a good weather without wind, a fixed-wing UVA may be used, and may be mounted with a high-resolution spectral camera to perform large-area earth surface scanning work in the key investigation area; and
(2) if the tunnel site area is a mountainous area with the topographic fluctuation exceeding a set threshold, there are obvious mountainous barriers, and it is difficult for the fixed-wing UAV to take off and land, a rotor-wing UAV is used. The rotor-wing UAV is suitable for investigation under complex conditions in mountainous areas.

Specifically, a processing process of the aerial image is as follows:
(1) preprocessing the spectral image, including radiation correction and atmosphere correction, so as to eliminate background noises generated in a data obtaining and transmission process and eliminate the impact of factors such as atmosphere and water vapor;
(2) extracting the spectrum feature information of each point in the key investigation area from the preprocessed spectrum image by using a spectrum angle matching method;
(3) performing the field on-site exploration, collecting the typical rocks and minerals in the tunnel site area, and establishing the lithology spectrum library; and
(4) matching the lithologic and mineral information of the key investigation area by using the spectrum feature information in combination with an existing spectrum database, and building the 3D geological model of the key investigation area.

Step 3: obtaining corresponding mineral and lithologic information based on a spectral test on the key investigation area possibly having an unfavorable geological body, and determining the position, range and scale of distribution of the unfavorable geological body in combination with an earth surface geophysical exploration result.

In a specific implementation process, first, on-site spectral testing is performed, mineral and lithologic information of the area is obtained by using a non-imaging spectral instrument, and comparative analysis with the mineral and lithologic information obtained based on the UAV remote sensing image is performed to further determine the type of unfavorable geology possibly presenting in the area. A matched geophysical exploration method is selected aiming at the type of the unfavorable geological body. Geophysical exploration is performed in the key investigation area possibly having an unfavorable geological body to obtain on-site geophysical exploration data. Inversion is performed on the geophysical exploration data to obtain a stratum model under the key investigation area. According to the geological model obtained through inversion, geological interpretation is performed to determine the position, range and scale of the unfavorable geological body (fault, fractured rock mass or aquifer).

Selection requirements of the geophysical exploration method are as follows:
(1) if an anomaly body with elasticity differences, for example, a fault fracture zone or fractured rock mass, needs to be explored, a seismic reflection method may be used; and
(2) if an aquifer needs to be positioned, a resistivity method or an induced polarization method may be used.

Step 4: obtaining image spectral information of a geological body around a tunnel working face inside the tunnel in a position of the tunnel working face, identifying mineral and lithologic information inside the tunnel, and then determining relative positions of the unfavorable geological body and the tunnel working face in combination with a geophysical exploration test inside the tunnel and a tunnel site area 3D geological model.

In a specific implementation process, a push-broom type spectral imager is installed and debugged in the position of the tunnel working face. A spectral imaging test is performed in the position of the tunnel working face to obtain image spectral information of the tunnel working face and surrounding rock mass thereof. Preprocessing is performed on the image spectral information, and then inversion is performed to obtain mineral and lithologic information of the tunnel working face and the surrounding rock mass thereof. An on-site geophysical exploration test is performed to obtain the position, range and scale of the unfavorable geological body in front of the tunnel working face. A tunnel geophysical exploration inversion result and the earth surface geophysical exploration result are comprehensively analyzed to further confirm the position, range and scale of the unfavorable geological body. By using a tunnel axis as a baseline and taking a range of 50 m at two sides of a peripheral line, the tunnel site area 3D geological model is built by using the digital elevation model data of the tunnel site area to determine the relative positions of the unfavorable geological body and the tunnel working face.

The preprocessing and inversion processes of the spectrum data are as follows:
(1) preprocessing the spectral image, including radiation correction and dark-field correction, so as to eliminate background noises generated in a data obtaining and transmission process;
(2) reading the processed high-spectral data into ENVI software to display a grayscale image and a color composite image; and
(3) extracting a spectral curve, and matching the lithologic and mineral information of the tunnel working face and the surrounding geological body by using the spectrum feature information in combination with an existing spectrum database.

A constructing process of the tunnel site area 3D geological model is as follows:
(1) by using a tunnel axis as a baseline and taking a range of 50 m at two sides of a peripheral line, building a 3D geological section of the tunnel site area by using the digital elevation model;
(2) according to the obtained relative position relationship between the unfavorable geological body and the tunnel working face and a distribution range of the unfavorable geological body, marking the unfavorable geological body on the 3D geological section; and
(3) collecting the lithologic and mineral information corresponding to each point of the tunnel working face and the surrounding rock mass to complete construction of the tunnel 3D geological model.

Step 5: determining a drilling position according to the tunnel site area 3D geological model and the relative positions of the unfavorable geological body and the tunnel working face, and finally, confirming the type and properties of the unfavorable geological body based on an on-site drilling test result.

Specifically, the drilling position is selected according to the position of the unfavorable geological body determined by using the geophysical exploration method, an on-site advanced drilling test is performed to analyze drilling parameters obtained in the drilling process, and the lithologic and mineral information of the unfavorable geological section is obtained. After the drilling is completed, a rock core extracted by a drill bit is subjected to spectrum scanning to identify the lithologic and mineral information, the information is compared with the lithologic and mineral information obtained through inversion of the drilling parameters, and accurate lithologic and mineral information of the unfavorable geological section is comprehensively analyzed. An obtained range of the unfavorable geological body is combined with the lithology and mineral type of the unfavorable geological body obtained in a next step to realize the identification on the “form” and “nature” of the unfavorable geological body. A tunnel construction plan is arranged by using the tunnel site area 3D geological model, and possible geological disasters may be prevented.

A process of performing inversion of the drilling parameters to obtain the lithologic and mineral information of the unfavorable geological section is as follows:
(1) performing an on-site advanced drilling test to obtain the drilling parameters in the drilling process, and the drilling parameters include a drilling speed V, a drilling thrust F, a drill bit rotating speed N, a drilling torque M, and a drilling depth D;
(2) performing data preprocessing to perform missing data compensation, abnormal data deletion, and redundant data monitoring on the obtained data;
(3) carrying out normalization processing on the five drilling parameters to obtain a drilling index of the unfavorable geological section; and
(4) matching the lithologic and mineral information of the unfavorable geological section by using the drilling index in combination with an existing drilling database.

### Example 2

The present example provides a space-sky-ground-tunnel-hole integrated unfavorable geology identification system, which includes:
a key investigation area determining module, configured to obtain satellite remote sensing image data and a digital elevation model along a tunnel site area, and determine a key investigation area through geological analysis;
an unfavorable geology type prediction module, configured to extract corresponding geological structure information and lithologic information based on a UAV remote sensing spectral image of the key investigation area, and recognize a type of unfavorable geology possibly presenting in the key investigation area;
an unfavorable geological body distribution determining module, configured to obtain corresponding mineral and lithologic information based on a spectral test on the key investigation area possibly having an unfavorable geological body, and determine the position, range and scale of distribution of the unfavorable geological body in combination with an earth surface geophysical exploration result;
a relative position determining module, configured to obtain image spectral information of a geological body around a tunnel working face inside the tunnel in a position of the tunnel working face, identify mineral and lithologic information inside the tunnel, and then determine relative positions of the unfavorable geological body and the tunnel working face in combination with a geophysical exploration test inside the tunnel and a tunnel site area 3D geological model; and
an abnormality verification module, configured to determine a drilling position according to the tunnel site area 3D geological model and the relative positions of the unfavorable geological body and the tunnel working face, and finally confirm the type and properties of the unfavorable geological body based on an on-site drilling test result.

As an implementation, in the relative position determining module, the 3D geological model of the tunnel is built according to investigation data of the tunnel site area.

As an implementation, in the key investigation area determining module, radar data is obtained in the tunnel site area by using a synthetic aperture radar interferometric measurement method, and a high-resolution digital elevation model is generated by processing the radar data.

As an implementation, spectrum feature, texture feature and geometrical feature information is extracted according to the remote sensing image data of the tunnel site area, and stratum lithologic and mineral information of the tunnel site area is obtained through inversion according to a corresponding relationship of the spectrum feature, texture feature and geometrical feature information with the minerals and the lithology.

As an implementation, the key investigation area determining module is further configured to:
extract topographic feature information of the tunnel site area by using the digital elevation model; and
predict an area having a fragile geological environment and a stability not meeting set requirements in the tunnel site area through the stratum lithologic and mineral information and the topographic feature, and mark the area as a potential geological disaster hidden danger area, i.e., the key investigation area.

It should be noted herein that each module in the present example is in one-to-one correspondence to each step in Embodiment 1, and the specific implementation processes thereof are the same, which will not be repeated herein.

### Example 3

The present example provides a computer-readable storage medium storing a computer program. The program, when executed by a processor, implements steps in the space-sky-ground-tunnel-hole integrated unfavorable geology identification method described above.

### Example 4

The present example provides a computer device, which includes a memory, a processor and a computer program stored on the memory and runnable on the processor. The processor, when executing the program, implements the steps in the space-sky-ground-tunnel-hole integrated unfavorable geology identification method described above.

The present invention is described with reference to the flowcharts and/or block diagrams of the method, the device (system), and the computer program product according to the embodiments of the present invention. It should be understood that computer program instructions can realize each procedure and/or block in the flowcharts and/or block diagrams and a combination of procedures and/or blocks in the flowcharts and/or block diagrams. These computer program instructions may be provided to a general-purpose computer, a dedicated computer, an embedded processor, or a processor of another programmable data processing apparatus to generate a machine, so that the instructions executed by the computer or the processor of the another programmable data processing apparatus generate an apparatus for implementing a specific function in one or more processes in the flowcharts and/or in one or more blocks in the block diagrams.

The foregoing descriptions are merely preferred embodiments of the present invention, but are not intended to limit the present invention. A person skilled in the art may make various alterations and variations to the present invention. Any modification, equivalent replacement, improvement and the like made within the spirit and principle of the present invention shall fall within the protection scope of the present invention.

1. A space-sky-ground-tunnel-hole integrated unfavorable geology identification method, comprising:
obtaining satellite remote sensing image data and a digital elevation model along a tunnel site area, and determining a key investigation area through geological analysis;
extracting corresponding geological structure information and lithologic information based on an unmanned aerial vehicle (UAV) remote sensing spectral image of the key investigation area, and recognizing a type of unfavorable geology possibly presenting in the key investigation area;
obtaining corresponding mineral and lithologic information based on a spectral test on the key investigation area possibly having an unfavorable geological body, and determining the position, range and scale of distribution of the unfavorable geological body in combination with an earth surface geophysical exploration result; wherein based on on-site spectral testing, mineral and lithologic information of the area is obtained by using a non-imaging spectral instrument, and comparative analysis with the mineral and lithologic information obtained based on the UAV remote sensing image is performed to further determine the type of unfavorable geology possibly presenting in the area; and a matched geophysical exploration method is selected aiming at the type of the unfavorable geological body;
obtaining image spectral information of a geological body around a tunnel working face inside the tunnel in a position of the tunnel working face, identifying mineral and lithologic information inside the tunnel, and then determining relative positions of the unfavorable geological body and the tunnel working face in combination with a geophysical exploration test inside the tunnel and a tunnel site area three-dimensional (3D) geological model; wherein a spectral imaging test is performed in the position of the tunnel working face to obtain image spectral information of the tunnel working face and surrounding rock mass thereof; and preprocessing is performed on the image spectral information, and then inversion is performed to obtain mineral and lithologic information of the tunnel working face and the surrounding rock mass thereof; and
determining a drilling position according to the tunnel site area 3D geological model and the relative positions of the unfavorable geological body and the tunnel working face, and finally confirming the type and properties of the unfavorable geological body based on an on-site drilling test result.

2. The space-sky-ground-tunnel-hole integrated unfavorable geology identification method according to claim 1, wherein the 3D geological model of the tunnel site area is built according to preliminary investigation data of the tunnel.

3. The space-sky-ground-tunnel-hole integrated unfavorable geology identification method according to claim 1, wherein radar data is obtained in the tunnel site area by using a synthetic aperture radar interferometric measurement method, and a high-resolution digital elevation model is generated by processing the radar data.

4. The space-sky-ground-tunnel-hole integrated unfavorable geology identification method according to claim 1, wherein spectrum feature, texture feature and geometrical feature information is extracted according to the remote sensing image data of the tunnel site area, and stratum lithologic and mineral information of the tunnel site area is obtained through inversion according to a corresponding relationship of the spectrum feature, texture feature and geometrical feature information with the minerals and the lithology;
topographic feature information of the tunnel site area is extracted by using the digital elevation model; and
an area having a fragile geological environment and a stability not meeting set requirements in the tunnel site area is predicted through the stratum lithologic and mineral information and the topographic feature, and is marked as a potential geological disaster hidden danger area, i.e., the key investigation area.

5. The space-sky-ground-tunnel-hole integrated unfavorable geology identification method according to claim 1, wherein an UAV mounted spectral camera is used for performing spectral imaging in the determined key investigation area.

6. The space-sky-ground-tunnel-hole integrated unfavorable geology identification method according to claim 1, wherein the mineral and lithologic information inside the tunnel is identified at the tunnel working face by using a push-broom type spectral imager.

7. A space-sky-ground-tunnel-hole integrated unfavorable geology identification system, comprising:
a key investigation area determining module, configured to obtain satellite remote sensing image data and a digital elevation model along a tunnel site area, and determine a key investigation area through geological analysis;
an unfavorable geology type prediction module, configured to extract corresponding geological structure information and lithologic information based on a UAV remote sensing spectral image of the key investigation area, and recognize a type of unfavorable geology possibly presenting in the key investigation area;
an unfavorable geological body distribution determining module, configured to obtain corresponding mineral and lithologic information based on a spectral test on the key investigation area possibly having an unfavorable geological body, and determine the position, range and scale of distribution of the unfavorable geological body in combination with an earth surface geophysical exploration result; wherein based on on-site spectral testing, mineral and lithologic information of the area is obtained by using a non-imaging spectral instrument, and comparative analysis with the mineral and lithologic information obtained based on the UAV remote sensing image is performed to further determine the type of unfavorable geology possibly presenting in the area; and a matched geophysical exploration method is selected aiming at the type of the unfavorable geological body;
a relative position determining module, configured to obtain image spectral information of a geological body around a tunnel working face inside the tunnel in a position of the tunnel working face, identify mineral and lithologic information inside the tunnel, and then determine relative positions of the unfavorable geological body and the tunnel working face in combination with a geophysical exploration test inside the tunnel and a tunnel site area 3D geological model; wherein a spectral imaging test is performed in the position of the tunnel working face to obtain image spectral information of the tunnel working face and surrounding rock mass thereof; and preprocessing is performed on the image spectral information, and then inversion is performed to obtain mineral and lithologic information of the tunnel working face and the surrounding rock mass thereof; and
an abnormality verification module, configured to determine a drilling position according to the tunnel site area three-dimensional (3D) geological model and the relative positions of the unfavorable geological body and the tunnel working face, and finally confirm the type and properties of the unfavorable geological body based on an on-site drilling test result.

8. The space-sky-ground-tunnel-hole integrated unfavorable geology identification system according to claim 7, wherein in the relative position determining module, the 3D geological model of the tunnel site area is built according to preliminary investigation data of the tunnel.

9. A computer-readable storage medium, storing a computer program, wherein the program, when executed by a processor, implements steps in the space-sky-ground-tunnel-hole integrated unfavorable geology identification method according to claim 1.

10. A computer device, comprising a memory, a processor and a computer program stored on the memory and runnable on the processor, wherein the processor, when executing the program, implements the steps in the space-sky-ground-tunnel-hole integrated unfavorable geology identification method according to claim 1.

11. The space-sky-ground-tunnel-hole integrated unfavorable geology identification method according to claim 2, wherein radar data is obtained in the tunnel site area by using a synthetic aperture radar interferometric measurement method, and a high-resolution digital elevation model is generated by processing the radar data.
